(19) United States
(12) Patent Application Publication
(10) Pub. No.: US 2015/0253763 A1
(43) Pub. Date: Sep. 10, 2015

(54) DATA GENERATION SYSTEM AND DATA GENERATION METHOD

(71) Applicant: DAINIPPON SCREEN MFG. CO., LTD., Horikawa-dori, Kamigyo-ku, Kyoto-shi (JP)

(72) Inventor: Tomoyasu Furuta, Kyoto (JP)

(73) Assignee: SCREEN Holdings Co., Ltd., Horikawa-dori, Kamigyo-ku, Kyoto-shi (JP)

(21) Appl. No.: 14/431,572

(22) PCT Filed: May 30, 2013
(86) PCT No.: PCT/JP2013/065014

§ 371 Date: Mar. 26, 2015

(30) Foreign Application Priority Data
Sep. 28, 2012 (JP) 2012-216144

(51) Int. Cl. G05B 19/418

(52) U.S. Cl. CPC G05B 19/418; G05B 2219/45031

(57) ABSTRACT

High-quality configuration data, which makes a substrate processing apparatus operate in accordance with the specifications of the substrate processing apparatus, is generated in a small number of man-hours. A data generation system includes: a storage part in which a plurality of mutually different specifications and a plurality of pieces of mutually different configuration data are hierarchically structured and stored and in which relevancy information indicative of the inter-hierarchical relevancy between the specifications and the configuration data is stored; a specifications acquiring part that acquires the specifications of the substrate processing apparatus; and a data generation part that selects configuration data corresponding to the specifications acquired by the specifications acquiring part from among the plurality of pieces of configuration data based upon the relevancy information, and generates configuration data which makes the substrate processing apparatus having the specifications acquired by the specifications acquiring part operate.

### TECHNICAL FIELD

The present invention relates to a data generation system of and a data generation method for generating configuration data which makes a substrate processing apparatus operate in accordance with the specifications of the substrate processing apparatus. The substrate processing apparatus includes an apparatus for executing processing of a substrate, including etching, development, cleaning and drying. The substrate includes various types of substrates such as a semiconductor wafer, a glass substrate for photo mask, a glass substrate for liquid crystal display, a glass substrate for plasma display, a substrate for FED (Field Emission Display), a substrate for optical disc, a substrate for magnetic disk and a substrate for magneto-optical disk.

### BACKGROUND ART

Various substrate processing apparatuses have been provided for manufacturing of electronic components such as semiconductor devices and liquid crystal display devices. Substrate processing apparatuses are products which would be manufactured after receipt of orders and designing, and even for the same model, these products often have different hardware, mechanisms, etc. Noting this, when software for controlling a substrate processing apparatus needs be created, configuration data is generated as described in Patent Document 1 for instance. That is, a computer program, which is the core of software, is standardized for various types of semiconductor processing apparatuses, while by configuration, individual functions of the computer program are switched according to the destinations, user requirements, product specifications and the like of the apparatuses. In this context, “product specifications” are determined by structural elements which form products and by the functions of the respective elements. In the following, the mere term “specifications” means what includes “product specifications,” a “destination” and a “user requirement.”

### CITATION LIST

### Patent Literature

PTL 1: JP2007-523407A

### SUMMARY OF INVENTION

### Technical Problem

However, as the number of products increases, the number of specifications increases and the number of setting items contained in configuration data becomes enormous. This has given rise to the following problems. The first problem is that generation of data demands a remarkably large number of man-hours. Further, typographical errors can easily occur during data generation, which has made it difficult to determine the validity of data. As a result, advanced expertise is today required for generation of high-quality configuration data.

Knowledge management of configuration data which has already been created may solve these problems. However, there has been no knowledge management which suits software development for substrate processing apparatuses.

The invention has been made in light of the problems above, and accordingly, an object of the invention is to provide a data generation technique for generating, in a small number of man-hours, high-quality configuration data which makes a substrate processing apparatus operate in accordance with the specifications of the substrate processing apparatus.

### Solution to Problem

One aspect of the invention is a data generation system that generates configuration data which makes a substrate processing apparatus operate in accordance with the specifications of the substrate processing apparatus, the system including: a storage part in which a plurality of mutually different specifications and a plurality of pieces of mutually different configuration data are hierarchically structured and stored and in which relevancy information indicative of the inter-hierarchical relevancy between the specifications and the configuration data is stored; a specifications acquiring part that acquires the specifications of the substrate processing apparatus; and a data generation part that selects configuration data corresponding to the specifications acquired by the specifications acquiring part from among the plurality of pieces of configuration data based upon the relevancy information, and generates configuration data which makes the substrate processing apparatus having the specifications acquired by the specifications acquiring part operate.

Other aspect of the invention is a data generation method for generating configuration data which makes a substrate processing apparatus operate in accordance with the specifications of the substrate processing apparatus, the method including: generating a knowledge database that contains hierarchical structure information, in which a plurality of mutually different specifications and a plurality of pieces of mutually different configuration data are hierarchically structured, and relevancy information which is indicative of the inter-hierarchical relevancy between the specifications and the configuration data; selecting configuration data that corresponds to the specifications of the substrate processing apparatus from the knowledge database based upon the relevancy information; and determining that thus selected configuration data is the configuration data which makes the substrate processing apparatus operate.

In the following, “knowledge” means the aggregation of learning and findings which determine associations in data. For example, the findings that “To realize the function A in the substrate processing apparatus, the unit X is necessary for the substrate processing apparatus,” the findings that “When the unit X is used, the relevant components a and b are necessary, but the component c is unnecessary,” the findings that “While the request Z1 can be chosen for the substrate processing apparatus which will be delivered to the plant Y located in the country X, the request Z2 cannot be chosen because of the safety standard,” etc. are knowledge, and the relevancy information above corresponds to knowledge. In addition, a database which contains specifications and configuration data together with relevancy information as that described above corresponds to a “knowledge database.”

### Advantageous Effects of Invention

As described above, according to the invention, configuration data is hierarchically structured in association with the specifications of the substrate processing apparatus. In this manner, the specifications and the configuration data are turned into a knowledge database in an easy-to-follow fashion to a software developer (hereinafter referred to as the “operator”). The knowledge database also contains relevancy information which is indicative of the inter-hierarchical relevancy between the specifications and the configuration data. The configuration data corresponding to the specifications of the substrate processing apparatus is chosen from the knowledge database based upon the relevancy information. It is therefore possible to reduce the man-hours of and typographical errors by the operator during data generation. Further, this makes it easy to determine the validity of data. In consequence, it is possible to create high-quality configuration data in a small number of man-hours.

### BRIEF DESCRIPTION OF DRAWINGS

FIG. 1 is a block diagram which shows the structure of the data generation system according to an embodiment of the invention.

FIG. 2 is a drawing which conceptually shows the structure of the knowledge database stored in the data generation system which is shown in FIG. 1.

FIG. 3 shows an example of the destination data layer contained in the knowledge database.

FIG. 4 shows an example of the user requirements data layer contained in the knowledge database.

FIG. 5 shows an example of the product specifications data layer contained in the knowledge database.

FIG. 6 shows an example of the related information table contained in the knowledge database.

FIG. 7 is a flow chart which shows the operation of the data generation system shown in FIG. 1.

FIG. 8 is a flow chart which shows the operation of the data generation system shown in FIG. 1.

FIG. 9 shows an example of the configuration data generated by the data generation system which is shown in FIG. 1.

FIG. 10 is a conceptual diagram of the forward-direction visualization function in the data generation system shown in FIG. 1.

FIG. 11 is a conceptual diagram of the forward-direction visualization function in the data generation system shown in FIG. 1.

FIG. 12 is a conceptual diagram of the reverse-direction visualization function in the data generation system shown in FIG. 1.

FIG. 13 is a conceptual diagram of the reverse-direction visualization function in the data generation system shown in FIG. 1.

### DESCRIPTION OF EMBODIMENTS

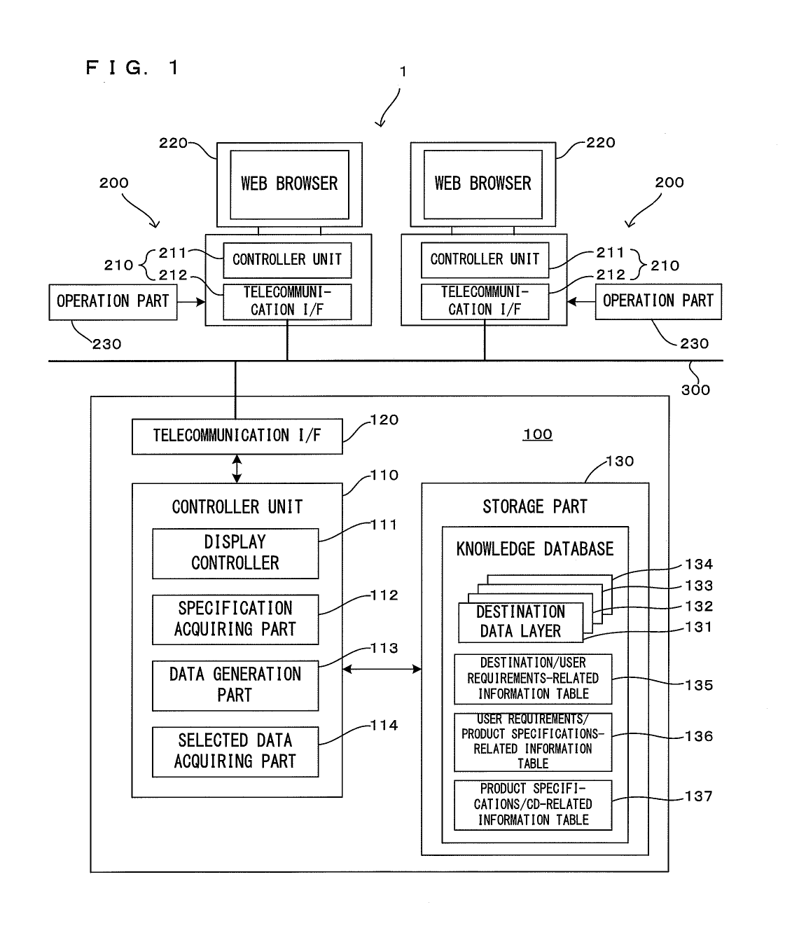

FIG. 1 is a block diagram which shows the structure of the data generation system according to an embodiment of the invention. The data generation system 1 comprises a system server 100 which generates configuration data which makes the substrate processing apparatus operate according to the specifications of the substrate processing apparatus and client terminals 200 in which WEB browser has been installed. The system server 100 and the client terminals 200 are able to communicate with each other via the Internet using a telecommunication network 300 which is a standardized telecommunication protocol such as TCP/IP (Transmission Control Protocol/Internet Protocol).

The client terminal 200 comprises a terminal main body part 210, a display part 220 such as a liquid crystal display and an operation part 230 which includes a keyboard and a mouse. A controller unit 211 and telecommunication I/F 212 which is for communicating with the system server 100 are incorporated within the terminal main body part 210. A computer comprising a CPU (Central Processing Unit), a memory and the like is a main section of the controller unit 211, and as the WEB browser starts up according to a program stored in advance within the memory, the display part 220 shows display information created by the system server 100. While there are two client terminals 200 for one system server 100 in the data generation system 1 shown in FIG. 1, the number of the client terminals 200 is not limited to this but may be any desired number.

The system server 100 comprises a controller unit 110, telecommunication I/F 120 which is for telecommunicating with the client terminals 200, and a storage part 130 which stores the knowledge database.

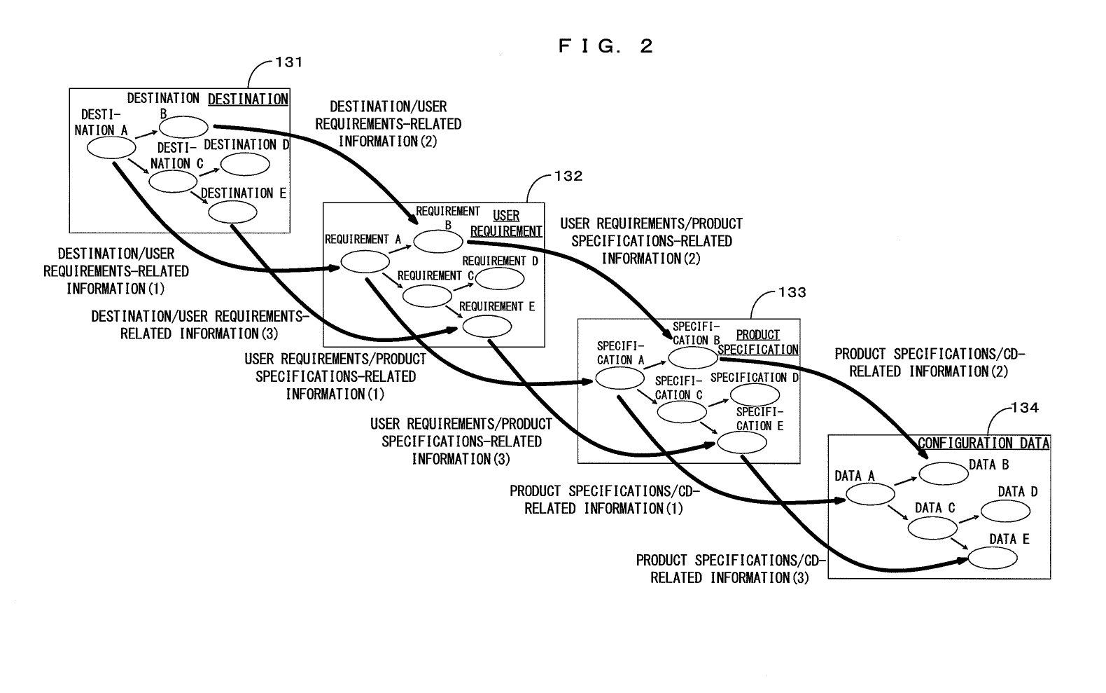

FIG. 2 is a drawing which conceptually shows the structure of the knowledge database stored in the data generation system which is shown in FIG. 1. The reference symbol CD in FIG. 2 is indicative of configuration data. In other drawings as well, configuration data is denoted as needed by the abbreviation “CD.”

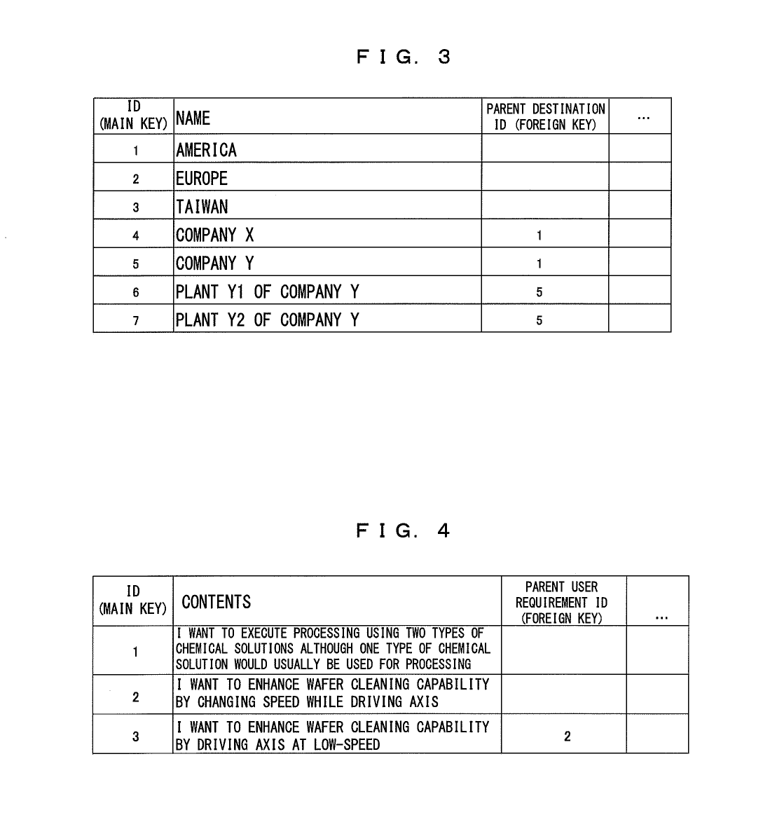

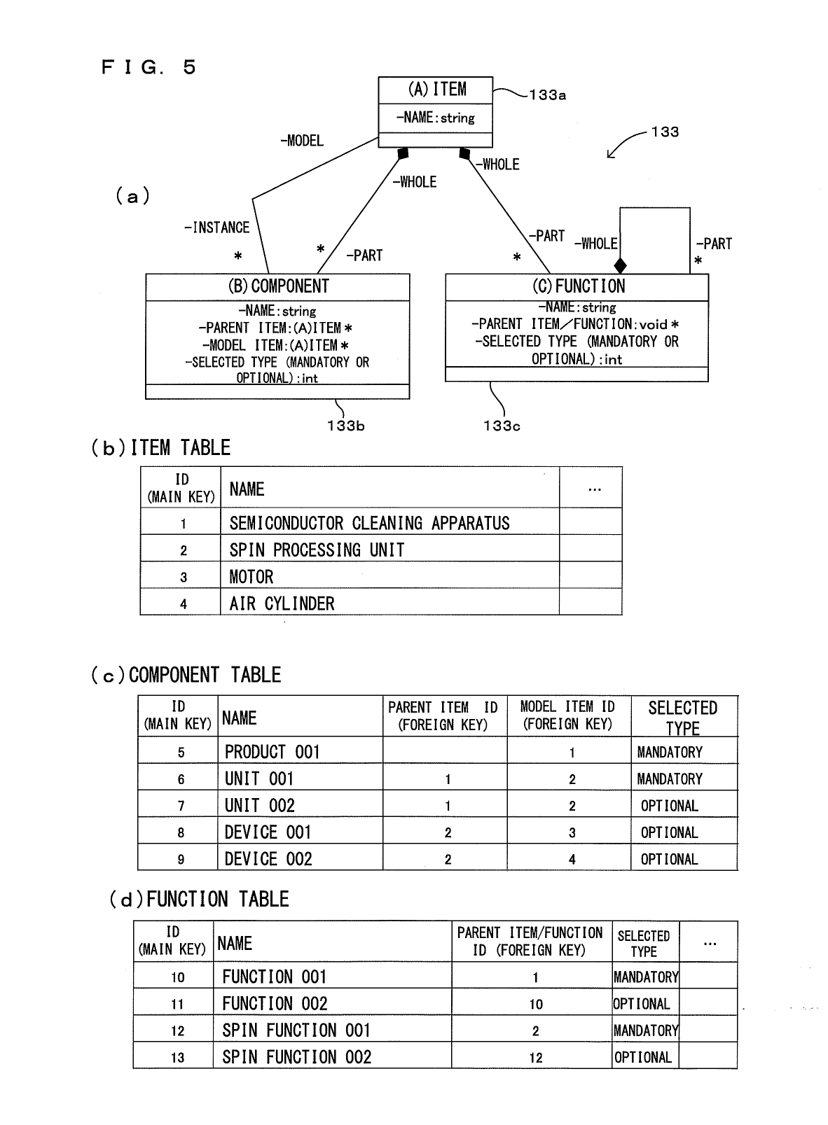

The knowledge database includes four data layers 131 through 134 and three tables 135 through 137 (FIG. 1). Of these data layers, the configuration data layer 134 is formed by a plurality of pieces of configuration data stored in the storage part 130. The remaining data layers 131 through 133 are formed by data concerning various types of specifications of the substrate processing apparatus which are necessary for generation of configuration data. In this embodiment, there are three types of specifications titled, “Destination,” “User Requirements” and “Product Specifications” which are set as the specifications of the substrate processing apparatus for which configuration data needs be generated. Data relevant to the destinations, the user requirements and the product specifications are divided respectively as the destination data layer 131 (FIG. 3), the user requirements data layer 132 (FIG. 4) and the product specifications data layer 133 (FIG. 5) and stored in the storage part 130. The data generation system 1 thus hierarchically holds the data concerning the specifications. Displaying the specifications data which can be selected so that the operator can choose or automatically determining different specifications data which matches the specifications data chosen by the operator and displaying these pieces of specifications data in a cascading form, the data generation system 1 generates the configuration data through joint work with the operator. The details of this will be described later.

A destination includes a country, a company, a plant and the like where the substrate processing apparatus will be installed as shown in FIG. 3 for example. A plurality of pieces of the destination data are hierarchically stored as two-step data in the destination data layer 131 shown in FIG. 3. For instance, with ID1 which is “America,” ID4 “Company X” and ID5 “Company Y” which have the value “Parent Destination ID1” are associated. Further, with ID5 “Company Y,” ID6 “Plant Y1 of Company Y” and ID7 “Plant Y2 of Company Y” which have the value “Parent Destination ID5” are associated. Hence, when the destination data layer 131 is referred to, one piece or plurality pieces of the destination data associated with one piece of destination data can be automatically specified. In addition to tracing the associations from the upper hierarchical layers toward the lower hierarchical layers as “America”->“Company Y”->“Plant Y1 of Company Y” and “Plant Y2 of Company Y,” it is also possible to trace the associations from the lower hierarchical layers toward the upper hierarchical layers as “Plant Y2 of Company Y”->“Company Y”->“America.”

In the user requirements data layer 132, typical requirements given from users regarding the substrate processing apparatus are stored as the user requirements data. They are for example a content that “I want to execute the processing using two types of chemical solutions although one type of chemical solution would usually be used for the processing.” or that “I want to enhance the wafer cleaning capability by changing the speed while driving the axis.” as shown in FIG. 4. The data stored in the data layer 132 as well is hierarchically structured so that it is possible to grasp the relevancy among the respective pieces of user requirements data. For instance, since ID3 “low-speed driving of the axis” is indispensable to realization of “change the speed while driving the axis” which is ID2, the user requirement indicated by ID2 and the user requirement indicated by ID3 are associated with each other as having a parent requirement-child requirement relationship. In short, the child requirement cannot be made valid when the parent requirement is invalid. As the user requirements data is hierarchically structured in this fashion, selection of one user requirement makes it possible to automatically set one or a plurality of user requirements which are relevant to the selected user requirement.

Further, user requirements are often different by destination. Noting this, in this embodiment, the destination-related data is positioned as upper rank data relative to the data regarding the user requirements and stored in the storage part 130 such that the destination data layer 131 and the user requirements data layer 132 are hierarchically structured.

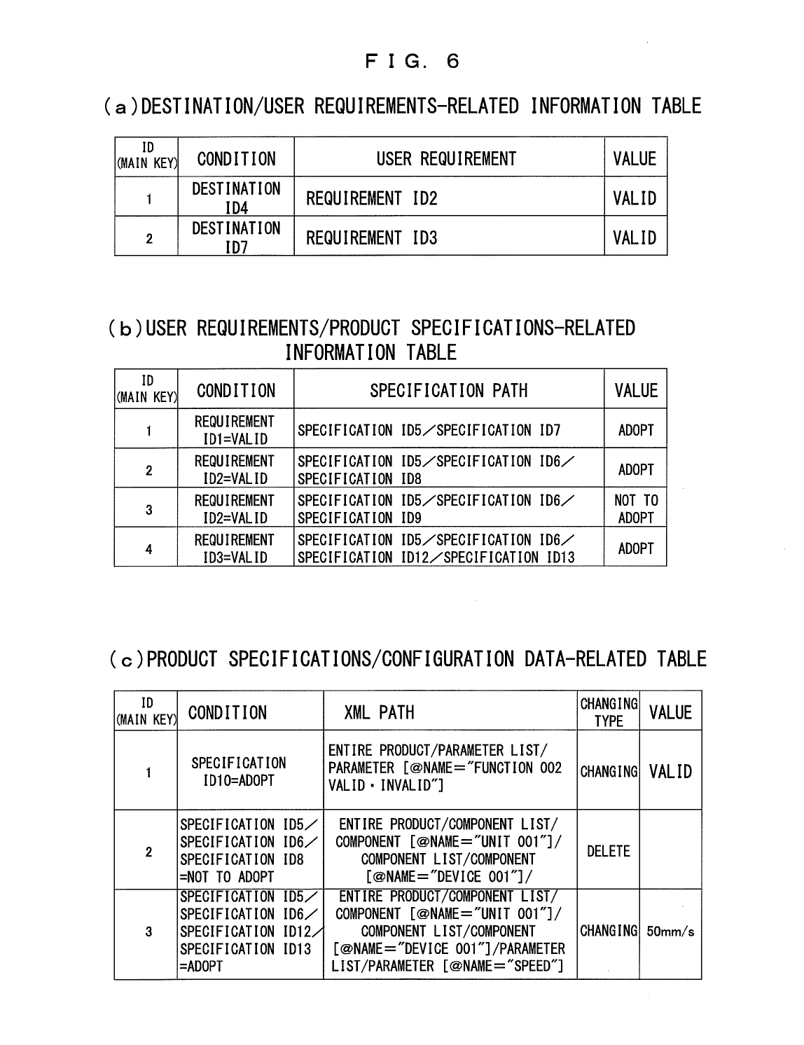

In addition, as shown in FIG. 6(a) for instance, information which associates the destinations with the user requirements is summarized in a destination/user requirements-related information table (hereinafter simply referred to as the “upper rank table”) 135 and stored in the storage part 130. For example, as indicated by the row for ID1 in FIG. 6(a), the user requirement ID2 is associated with the destination ID4 (ID4 “Company X” in FIG. 3). Hence, when the operator chooses the destination ID4, the user requirements data representing the requirement ID2 becomes valid. Meanwhile, the user requirement ID3 is associated with the destination ID7 (ID7 “Plant Y2 of Company Y” in FIG. 3). Therefore, when the operator chooses the destination ID7, the user requirements data representing the requirement ID3 becomes valid. As the destination is thus designated, it is possible to automatically determine the contents which a user would demand based upon the upper rank table 135.

As the user requirements are determined, it is possible to determine the corresponding product specifications to a certain extent (or within a certain range), which is empirically known. In this embodiment therefore, data regarding the user requirements is positioned as being upper-ranked relative to data concerning the product specifications and stored within the storage part 130 such that “the user requirements data layer 132” and “the product specifications data layer 133” are hierarchically structured. In the product specifications data layer 133, items such as which components form the product (substrate processing apparatus) and which components have which functions are managed as a database, including optional components and functions.

FIG. 5 shows an example of the product specifications data layer according to this embodiment. FIG. 5(a) in particular is a class diagram for describing the product specifications data layer which is written by UML (Unified Modeling Language) which is a standardized language for describing specifications for the purpose of object modeling in the field of software. engineering. In FIG. 5(a), denoted at the reference symbols 133a through 133c are “Item Class,” “Component Class” and “Function Class.” The item class 133a is indicative of the models of the components which are structural elements which form the product, can have a plurality of components or functions, and has “Name” as an attribute. In this embodiment, as shown in FIG. 5(b), “Semiconductor Cleaning Apparatus,” “Spin Processing Unit” and the like are included as the names of items which form the substrate processing apparatus. The component class 133b is indicative of the structural elements which form the product, and has “Name,” “Parent Item,” “Model Item” and “Selected Type (Mandatory or Optional)” as attributes. In this embodiment, as shown in FIG. 5(c), those components of which the items are parents and of which the names are “Product 001,” “Unit 001” and the like are included. The function class 133c has “Name,” “Parent Item/Function” and “Selected Type (Mandatory or Optional)” as attributes. In this embodiment, as shown in FIG. 5(d), those functions of which the items and the functions are parents and of which the names are “Function 001,” “Function 002” and the like are included.

In the product specifications data layer 133, the relative relationships between the components and the functions which may potentially be used in the substrate processing apparatus and distinction between essential and optional are set forth. As the components table (FIG. 5(c)) shows, the items and the components are associated with each other in the product specifications data layer 133. For instance, with the semiconductor cleaning apparatus (ID1, Name: “Product 001”), two types of spin processing units, namely, “Unit 001” (ID6) and “Unit 002” (ID7) are associated. As the column for the selected type for ID6 shows, while “Unit 001” is a mandatory element, “Unit 002” is an optional element. With the spin processing unit (ID2), “Device 001 (ID8, Name: Motor)” and “Device 002 (ID9, Name: Motor)” are associated as optional components. Further, as the functions table (FIG. 5(d)) shows, the items and the functions are associated with each other in the product specifications data layer 133. For instance, with the semiconductor cleaning apparatus, “Function 001” is associated as a mandatory element. With “Function 001,” “Function 002” is associated as an optional function. The functions table thus holds the data in a multi-layer structure.

Further, as shown in FIG. 6(b), information which associates the user requirements with the product specifications is summarized in a user requirements/product specifications-related information table (hereinafter simply referred to as the “middle rank table”) 136 and stored in the storage part 130. For instance, as indicated by the row for ID1, setting is that when the requirement ID1 is “valid,” combination of the specifications ID5 (“Product 001” shown in FIG. 5(c)) and the specifications ID7 (“Unit 002”) is adopted as the product specifications. In a similar manner, as indicated by the row for ID2, setting is that when the requirement ID2 is “valid,” combination of the specifications ID5 (“Product 001”), the specifications ID6 (“Unit 002”) and the specifications ID8 (“Device 001”) is adopted as the product specifications. Further, as indicated by the row for ID3, setting is that when the requirement ID2 is “valid,” combination of the specifications ID5 (“Product 001”), the specifications ID6 (“Unit 002”) and the specifications ID9 (“Device 002”) is not adopted as the product specifications. It is thus possible to automatically determine the product specifications based upon the user requirements and the middle rank table 136.

Further, once the product specifications are determined, it is possible to automatically determine the corresponding configuration data. Data concerning the product specifications are positioned as being upper ranked relative to configuration data and stored in the storage part 130 such that “the product specifications data layer 133” and “the configuration data layer 134” are hierarchically structured. In addition, information which associates the product specifications with the configuration data is summarized in a product specifications/configuration data-related information table (hereinafter simply referred to as the “lower rank table”) 137 and stored in the storage part 130. It is therefore possible to automatically determine the configuration data based upon the product specifications and the lower rank table 137.

In this embodiment, as shown in FIG. 2 for instance, hierarchical structuring is performed in the sequence of the destinations, the user requirements, the product specifications and the configuration data, and the specifications and the configuration data is associated with each other based upon the destination/user requirements-related information, the user requirements/product specifications-related information and the product specifications/configuration data-related information.

Referring back to FIG. 1, the structure of the data generation system 1 will be continuously described. A computer comprising a CPU, a memory and the like is a main section of the controller unit 110, and in accordance with a program stored within the memory in advance, the controller unit 110 functions as a display controller 111, a specifications acquiring part 112, a data generation part 113 and a selection data acquiring part 114. A WWW (World Wide Web) server program operates within the controller unit 110 so that display information stored in the memory can be viewed using the WEB browser on the client terminals 200.

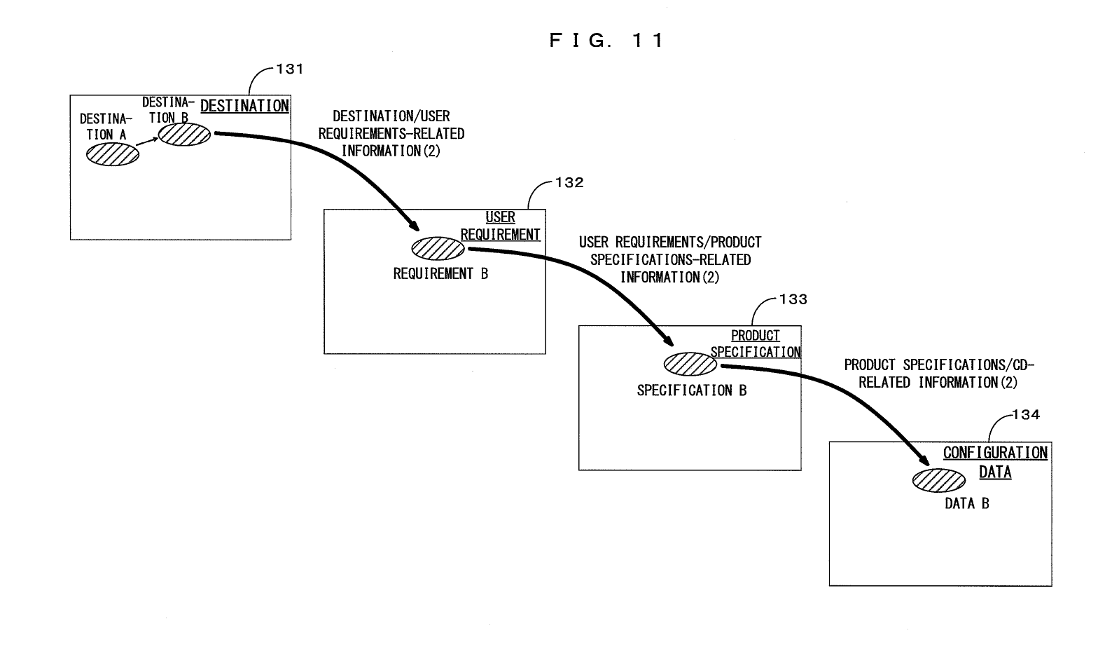

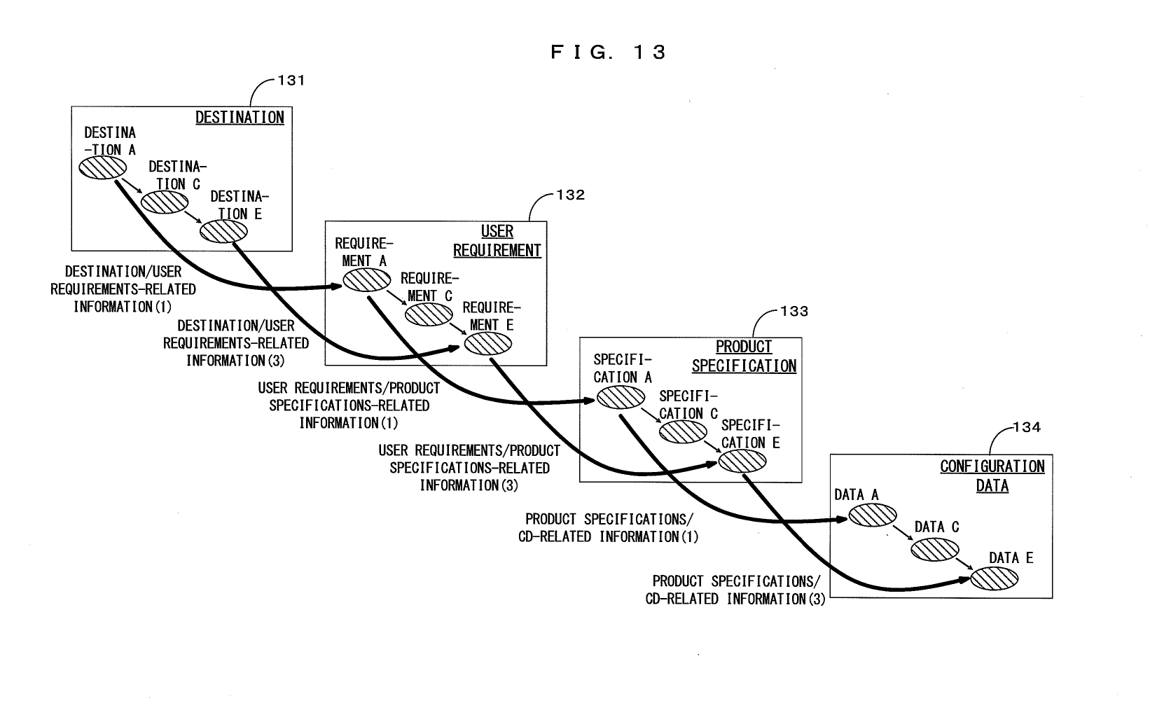

The display controller 111 controls the display information described above and accordingly switches display contents to be displayed on the WEB browser. For instance, when the operator manipulates the WEB browser on the client terminal 200 and demands the knowledge database as whole to be displayed, the display controller 111 creates the display information which hierarchically charts the knowledge database as shown in FIG. 2 for example based upon the data layers 131 through 134 and the tables 135 through 137 which are stored in the storage part 130. The WEB browser then makes the display part 220 display the chart as that shown in FIG. 2. FIG. 2 is a conceptual drawing of the knowledge database, and for the purpose of facilitating understanding of the concept, the state shown is that the number of the data and the number of the relevancy information in each data layer are significantly reduced. Further, it is possible to switch as needed between displaying of only the data and the information which are relevant to the specifications acquired by the specification acquiring part 112 as a chart (FIG. 10) and displaying of only the data and the information which are relevant to the configuration data acquired by the selected data acquiring part 114 as a chart (FIG. 12). Such pin-point visualization of a part of the knowledge database, namely, database visualization will be described in detail later.

The specification acquiring part 112 acquires the information concerning the specifications which the operator enters on the client terminals 200, and provides the data generation part 113 with the entered specifications information. The selected data acquiring part 114 acquires the information concerning the configuration data which the operator selects on the client terminals 200, and provides the data generation part 113 with the selected data information.

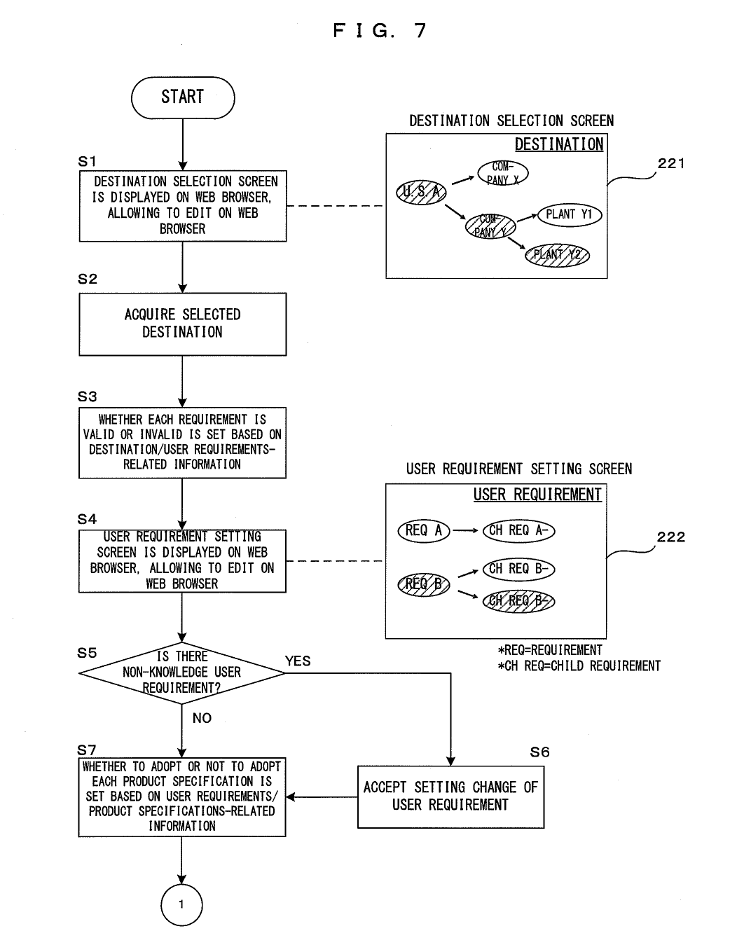

The data generation part 113 generates configuration data which corresponds to the specifications received from the specification acquiring part 112 based upon the knowledge database. Further, the data generation part 113 comprises a knowledge database visualization function in addition to the data generation function. A method by which the data generation system 1 shown in FIG. 1 generates configuration data will now be described with reference to FIGS. 7 through 9, and the visualization function above will be described with reference to FIGS. 10 and 12.

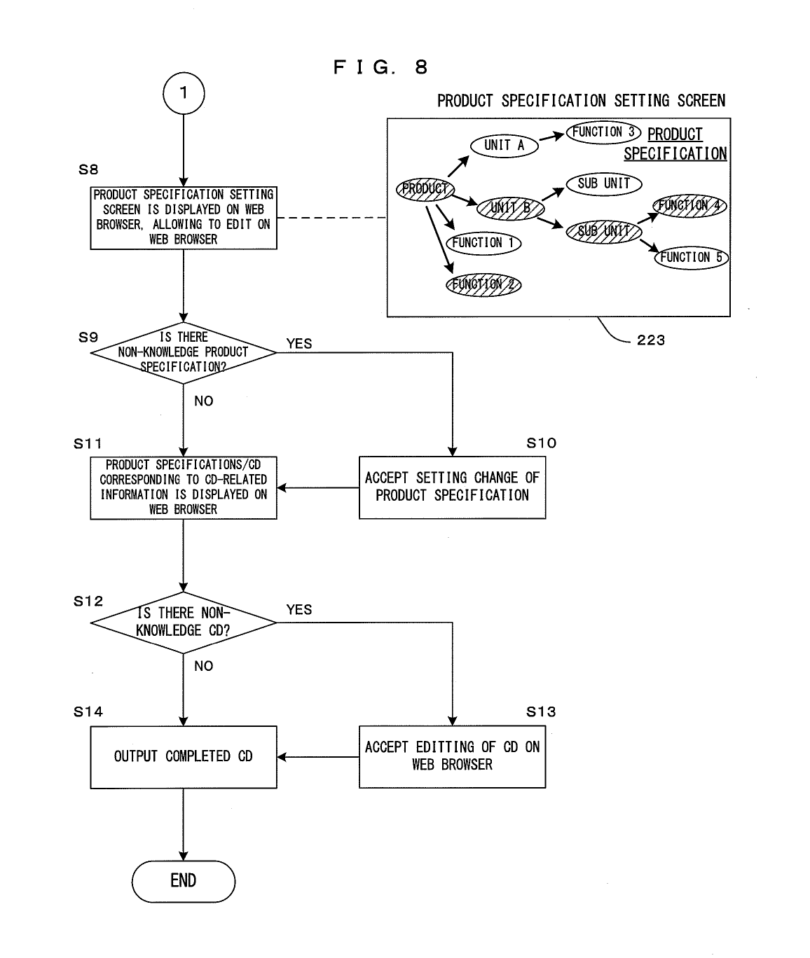

FIGS. 7 and 8 are flow charts which show the operations of the data generation system shown in FIG. 1. When configuration data which matches the substrate processing apparatus which will be installed at a certain destination are to be generated, the operator provides an instruction for generation of configuration data via the client terminal 200 of the data generation system 1. In response, as the system server 100 works with the client terminal 200 while having bidirectional telecommunication with the client terminal 200 via the telecommunication network 300, the data generation system 1 generates configuration data which matches the substrate processing apparatus described above.

Once the job of generating data starts, the WEB browser makes the display part 220 display a screen which is suitable for selecting the destination such as a destination selection screen 221 as that shown in an upper right section of FIG. 7 for instance, allowing the operator to enter and edit the destination (Step S1). In the selection screen 221, the destinations are displayed step by step in the sequence of the country, the company and the plant so that it is possible to easily select down the destination from the country level to the plant level. For example, as “Plant Y2” is selected as the destination on the WEB browser, as the selection screen 221 shows, “Plant Y2” which is selected and “Company Y” and “America” which are relevant are highlighted (shadowed in the selection screen 221 shown in FIG. 7).

In the event that the destination of the substrate processing apparatus for which data needs be generated is already on the selection screen 221, the operator manipulates the mouse or the like included in the operation part 230 and accordingly chooses the destination as in the example described earlier. On the other hand, when the destination of the substrate processing apparatus for which data needs be generated is not on the selection screen 221, the operator adds a new destination or changes the existing destination by the WEB browser.

Upon selection or entry of the destination of the substrate processing apparatus through the WEB browser, the system server 100 acquires the destination (Step S2). Whether each requirement is valid or invalid is then automatically set in accordance with the destination/user requirements-related information contained in the upper rank table 135 (Step S3).

Further, a user requirements setting screen 222 as that shown in a central right section of FIG. 7 for instance is displayed so that the operator can edit user requirements (Step S4).

The user requirements setting screen 222 shows the user requirements stored and turned into knowledge within the storage part 130 (which may for example be the requirement A, the child requirement A-, the requirement B and the child requirements B-, B-), and whether each requirement is valid or invalid is automatically set. In the selection screen 222 shown in FIG. 7, the valid requirement or the valid child requirement appears shaded.

Next, the situation that there is a user requirement which is not stored in the storage part 130, i.e., there is a non-knowledge user requirement which has not become knowledge (“YES” at Step S5) will be described. For instance, it is assumed that “Plant Y2” (the destination data layer 131) and “User Requirement A” (the user requirements data layer 132) are not associated with each other. In this instance, when “Plant Y2” is selected at Step 1, based upon the destination/user requirements-related information, “User Requirement A” becomes invalid automatically, and “User Requirement A” is not highlighted in the user requirements setting screen 222. However, if it becomes necessary to choose “User Requirement A” for “Plant Y2” to respond to a special request or for other reason, the operator selects “YES” at Step S5. This makes it possible on the user requirements setting screen 222 to accept editing such as addition and changing of the user requirements (Step S6). The operator, editing on the screen 222 using the mouse, etc., can make the requirement A which is currently invalid change to valid. Editing to make the child requirement A- alone valid is nevertheless impossible as long as the parent requirement A is invalid. As a result of the editing, relevancy information which is indicative of the association of the requirement A acquired at Step S2 with the upper rank layer data (“Plant Y2”->“Requirement A”->“Child Requirement A-”) is created. The relevancy information described above is data which is held tentatively until completion of setting of configuration data, i.e., data which is not reflected in the destination/user requirements-related information table 135. The operation for editing and temporarily holding non-knowledge data is similar also for non-knowledge product usage and non-knowledge configuration data which will be described later.

When it is determined that there is not a non-knowledge user requirement at Step S5 or editing is completed at Step S6, whether to adopt or not to adopt the product specifications is automatically set in accordance with the user requirements/product specifications-related information which is contained in the middle rank table 136 (Step S7). In addition, the WEB browser makes the display part 220 display a product specifications setting screen 223 as that shown in an upper right section of FIG. 8 for instance so that the operator can edit the product specifications (Step S8). In the setting screen 223 shown in FIG. 8, the adopted product specifications (the product, the units, the sub units and the functions) appear shaded.

The product specifications setting screen 223 shows the product specifications stored and turned into knowledge within the storage part 130, and whether to adopt or not to adopt the product specifications is automatically set. If there are product specifications which are not stored in the storage part 130, i.e., there are non-knowledge product specifications which have not become knowledge (“YES” at Step S9), as in the case of user requirements, editing such as addition and changing of product specifications through the WEB browser is accepted (Step S10).

When it is determined that there are not non-knowledge product specifications at Step S9 or editing is completed at Step S10, the configuration data which corresponds to the product specifications/configuration data-related information contained in the lower rank table 137 are selectively extracted, and the WEB browser makes the display part 220 show the configuration data (Step S11). In the event that there is configuration data which is not stored in the storage part 130, i.e., there is non-knowledge configuration data which has not become knowledge (“YES” at Step S12), as in the case of user requirements, editing such as addition and changing of the configuration data through the WEB browser is accepted (Step S13).

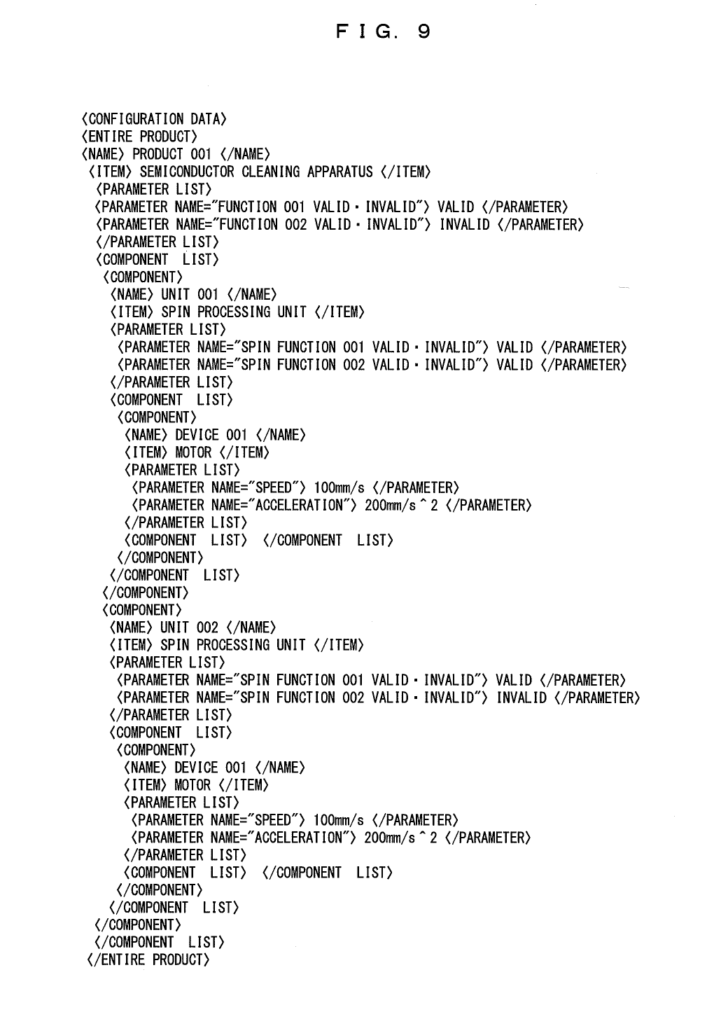

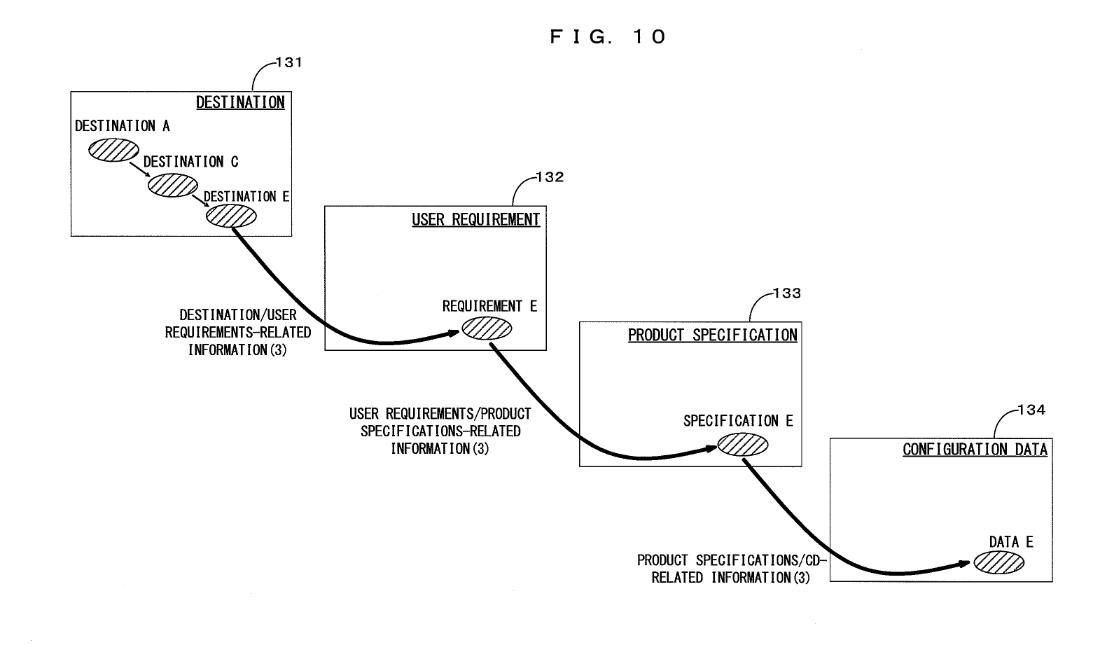

When it is determined that there is not non-knowledge configuration data at Step S12 or editing is completed at Step S13, configuration data which matches the substrate processing apparatus for which data needs be generated, e.g., configuration data in the XML (Extensible Markup Language) format is completed as shown in FIG. 9 for instance. The data generation system 1 then outputs this configuration data (Step S14). In this embodiment, an XML database is used since the configuration data is written in the XML format.

As described above, in this embodiment, as shown in FIG. 2, the destination, the user requirements and the product specifications are set as the specifications of the substrate processing apparatus, and the configuration data is associated with them and structured into the four-layer structure. The specifications and the configuration data are thus turned into the knowledge database in an easy-to-follow fashion to the operator. In addition, the knowledge database contains the three relevancy information (knowledge) which is indicative of the inter-hierarchical relevancy among the destination data layer, the user requirements data layer, the product specifications data layer and the configuration data. In accordance with the relevancy information, the configuration data which corresponds to the specifications of the substrate processing apparatus is selected from the knowledge database. It is therefore possible to reduce the man-hours of and typographical errors by the operator during generation of data. Further, it is easy to determine the validity of the data. In consequence, it is possible to efficiently create high-quality configuration data in a small number of man-hours.

In addition, during data generation, for every non-knowledge data, the WEB browser allows editing and addition of the data to the knowledge database. Like non-knowledge data, the relevancy information as well is edited and added to the knowledge database as needed. It is therefore possible to grow the knowledge database and create data more easily at a high accuracy through repeated editing and addition.

By the way, in the embodiment above, the knowledge database is formed by the four data layers and the three relevancy information, which makes it easy to understand the data structure even for a category of business in which manufacturing follows receipt of an order and designing. In other words, it is possible to intuitively understand direct or secondary influence of data selection at the upper rank data layer over the data contained in the subsequent data layers. However, data and relevancy information are added in accordance with a progress in development. Therefore, the knowledge database inevitably becomes complex, which may make editing difficult.

Further, data selection at the upper rank data layer may influence the lower rank data layers in a chain reaction: the influence may be over not only the data layer which is immediately below but over the data layers which are further below as well. Moreover, it is sometimes desirable to consider during data generation how data selection at the lower rank data layer may influence the upper rank data layers. While understanding data at which layer is influenced by data selection at a certain layer is thus important during data generation, skill is necessary for this understanding as the number of data increases.

Noting this, the data generation system 1 shown in FIG. 1 comprises two types of visualization functions, namely, (1) the function of visualizing the forward-direction influence of data selection at the upper rank data layer over the lower rank data layers and (2) the function of visualizing the reverse-direction influence of data selection at the lower rank data layer over the upper rank data layers. Even the operator who is not skilled can therefore intuitively understand how influential data selection at a certain layer is over data belonging to the other layers.

FIG. 10 is a conceptual diagram of the forward-direction visualization function in the data generation system shown in FIG. 1. In the data generation system 1, as the operator manipulates the operation part 230 of the client terminal 200 and executes the forward-direction visualization function, the controller unit 110 of the system server 100 operates according to a forward-direction visualization program which is stored in the memory in advance. Describing this in detail, when the operator selects data which the operator desires to visualize (for instance, the destination E included in the destination data layer in FIG. 10) using the WEB browser, the display part 220 displays only the selected data and the data belonging to the lower rank data layers which are influenced by the selected data (FIG. 10). From the chart displayed in the display part 220, the influence in the forward direction starting with the selected data can therefore be intuitively and easily understood. Although the destination is selected in the example in FIG. 10, when the data contained in the user requirements data layer or the product specifications data layer is selected, the influence in the forward direction starting with this data is displayed in the display part 220.

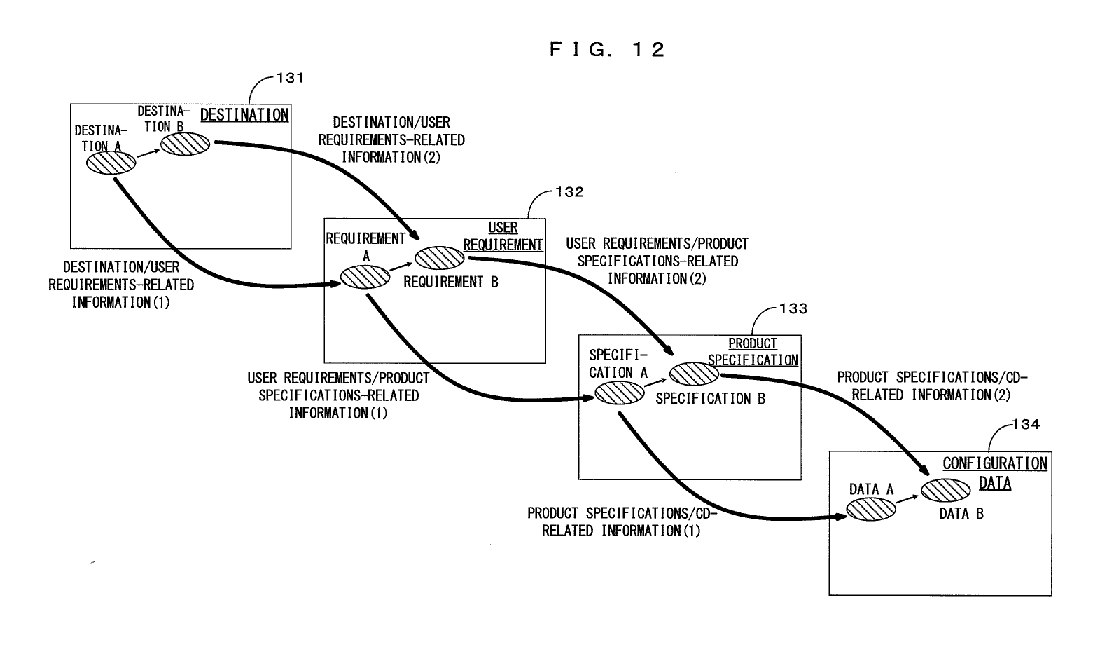

Further, it is also possible to change the specifications of the various types in this screen. For instance, it is assumed that the operator changes the destination from the destination E to the destination B. In this instance, as shown in FIG. 11, the data layers which are below the destination data layer 131 are rewritten in sequence, in accordance with which due to the visualization program, the cascading influence of the change of the specifications at the user requirements data layer 132 is shown to the operator in an intuitive fashion. In addition, the setting of the user requirements and the product specifications described in relation with Step S6 shown in FIG. 7 can also be changed on this screen, in which case as well the operator can intuitively understand the cascading influence as that shown in FIG. 11.

FIG. 12 is a conceptual drawing of the reverse-direction visualization function in the data generation system shown in FIG. 1. In the data generation system 1, as the operator manipulates the operation part 230 of the client terminal 200 and executes the reverse-direction visualization function, the controller unit 110 of the system server 100 operates according to a reverse-direction visualization program which is stored in the memory in advance. Describing this in detail, visualization in the opposite direction to the forward direction is executed. That is, when the operator selects data which the operator desires to visualize (for instance, the configuration data B included in the configuration data layer in FIG. 12) using the WEB browser, the display part 220 displays only the selected data and the data belonging to the upper rank data layers which are influenced by the selected data (FIG. 12). From the chart displayed in the display part 220, the influence in the reverse direction starting with the selected data can therefore be intuitively and easily understood. Although the configuration data is selected in the example in FIG. 12, when the data contained in the user requirements data layer or the product specifications data layer is selected, the influence in the reverse direction starting with this data is displayed in the display part 220.

On this screen as well, the various types of the specifications and the setting concerning the user requirements and the product usage can be changed. For instance, when the operator changes the configuration data from the data B to the data E using the mouse or the like, the reverse-direction visualization program changes the screen shown in FIG. 12 to the screen shown in FIG. 13.

Tracing in the reverse direction from the configuration data E tells that the product specifications E are necessary which are not demanded for the configuration data B. It is also seen that the user requirement B is not satisfied. The operator who generates and edits the configuration data, when referring to the screen shown in FIG. 13, can intuitively understand how modification of the configuration data changes the upstream side.

As described above, owing to the visualization functions, even the operator who is not skilled can intuitively understand how data selected at a certain layer influences the data contained in the other layers. The operator can therefore accurately set the items. Further, the visualization functions make it easier to determine the accuracy of and omission in the relevancy information, etc., and makes it possible to appropriately update the relevancy information. In addition, the charts displayed in the display part 220 due to the visualization functions can be used as reference for fine-tuning of the data which is set in the knowledge database. It is therefore possible to efficiently brush up the knowledge database.

The invention is not limited to the embodiment described above but may be modified in various manners in addition to the embodiments above, to the extent not deviating from the object of the invention. For instance, although the configuration data is written in the XML format in the embodiment above, the data format is not limited to this but may be other format such as the CSV (Comma Separated Values) format and the INI format. Further, while use of a relational database is preferable when the configuration data is in the CSV format or the INI format, the type of the database is not limited to an XML database or a relational database as described above but may be any desired type as in the case of the data format.

Further, although the client terminals 200 are provided and WEB browser is started on the client terminals 200 for selection of the various types of data, editing of the data, etc. according to the embodiment above, the client terminals 200 are not essential structures in the invention. In short, the system server 100 may comprise a display part, an operation part and the like and may execute the entire processing.

Further, although the destination, the user requirements and the product specifications are set as the specifications of the substrate processing apparatus and these three types of the specifications are stored as the hierarchical structures according to the embodiment above, the types of the specifications of the substrate processing apparatus and the number of hierarchical layers may be determined as desired. However, in the event that the specifications of the substrate processing apparatus are structured as two, four or more types, it is necessary to create relevancy information which is indicative of the inter-hierarchical relevancy and store the same in the storage part 130, which is similar to the embodiment described above.

In the embodiment above, relevancy information which has not become non-knowledge created at Step S6, etc. is only tentatively held and is not stored as perpetual information. However, this information may be reflected as perpetual information in a table such as the destination/user requirements-related information table 135 or the like.

### INDUSTRIAL APPLICABILITY

The invention is generally applicable to data generation techniques for generating configuration data which makes a substrate processing apparatus operate in accordance with the specifications of the substrate processing apparatus.

### REFERENCE SIGNS LIST

1 . . . data generation system
100 . . . system server
111 . . . display controller
112 . . . specifications acquiring part
113 . . . data generation part
114 . . . selection data acquiring part
130 . . . storage part
131 . . . destination data layer
132 . . . user requirements data layer
133 . . . product specifications data layer
134 . . . configuration data layer
135 . . . destination/user requirements-related information table
136 . . . user requirements/product specifications-related information table
137 . . . product specifications/configuration data-related information table
220 . . . display part

1. A data generation system that generates configuration data which makes a substrate processing apparatus operate in accordance with the specifications of the substrate processing apparatus, the system comprising:
a storage part in which a plurality of mutually different specifications and a plurality of pieces of mutually different configuration data are hierarchically structured and stored and in which relevancy information indicative of the inter-hierarchical relevancy between the specifications and the configuration data is stored;
a specifications acquiring part that acquires the specifications of the substrate processing apparatus; and
a data generation part that selects configuration data corresponding to the specifications acquired by the specifications acquiring part from among the plurality of pieces of configuration data based upon the relevancy information, and generates configuration data which makes the substrate processing apparatus having the specifications acquired by the specifications acquiring part operate.

2. The data generation system according to claim 1, wherein the storage part further hierarchically structures and stores the plurality of specifications, and stores relevancy information which is indicative of the inter-hierarchical relevancy among the specifications.

3. The data generation system according to claim 1, further comprising a display part that displays the hierarchical structure of the plurality of specifications and the plurality of pieces of configuration data.

4. The data generation system according to claim 3, wherein as the specifications acquiring part acquires the specifications, the display part selectively displays only the hierarchical structure of the specifications acquired by the specifications acquiring part and the configuration data which is relevant to the acquired specifications.

5. The data generation system according to claim 3, further comprising a data selecting part that receives selection of one piece of configuration data from among the plurality of pieces of configuration data, wherein
as the data selecting part receives selection of the configuration data, the display part selectively displays only the hierarchical structure of the configuration data received by the data selecting part and the specifications which are relevant to the received configuration data.

6. The data generation system according to claim 1, wherein when the storage part does not contain the configuration data which corresponds to the specifications acquired by the specifications acquiring part, the data generation part allows editing of the configuration data which corresponds to the acquired specifications.

7. The data generation system according to claim 6, wherein the data generation part writes into the storage part thus edited configuration data and the relevancy information concerning the edited configuration data and the specifications acquired by the specifications acquiring part.

8. A data generation method for generating configuration data which makes a substrate processing apparatus operate in accordance with the specifications of the substrate processing apparatus, the method comprising:
generating a knowledge database that contains hierarchical structure information, in which a plurality of mutually different specifications and a plurality of pieces of mutually different configuration data are hierarchically structured, and relevancy information which is indicative of the inter-hierarchical relevancy between the specifications and the configuration data;
selecting configuration data that corresponds to the specifications of the substrate processing apparatus from the knowledge database based upon the relevancy information; and
determining that thus selected configuration data is the configuration data which makes the substrate processing apparatus operate.
